(19) United States
(12) Patent Application Publication
(10) Pub. No.: US 2018/0031683 A1
(43) Pub. Date: Feb. 1, 2018

(54) COMBINED STRUCTURE OF PIEZOELECTRIC RECEIVER AND ULTRASONIC GENERATOR

(71) Applicant: Goertek.Inc, Weifang City, Shandong (CN)

(72) Inventors: Kang PING, Weifang City (CN); Xinfeng YANG, Weifang City (CN)

(21) Appl. No.: 15/551,203

(22) PCT Filed: Nov. 16, 2015
(86) PCT No.: PCT/CN2015/094734

§ 371 Date: Aug. 15, 2017

(30) Foreign Application Priority Data
Mar. 31, 2015 (CN) 201510149037.5

(51) Int. Cl. G01S 7/521; H04R 17/00

(52) U.S. Cl. CPC G01S 7/521; H04R 17/00; G01S 7/539

(57) ABSTRACT

The present invention discloses a combined structure of a piezoelectric receiver and an ultrasonic generator comprises a piezoelectric plate, an ultrasonic signal generator, an audio signal input circuit and a switching circuit, wherein the input end of the switching circuit is connected with the ultrasonic signal generator and the audio signal input circuit, respectively, so as to switch therebetween; and the output end of the switching circuit is connected with the piezoelectric plate. The technical effect of the present invention is that the piezoelectric receiver and the ultrasonic generator are combined, such that functions of the receiver and the ultrasonic generator can be achieved only through one piezoelectric plate, saving the cost and the space.

This application is a National Stage of International Application No. PCT/CN2015/094734, filed Nov. 16, 2015, which claims priority to Chinese Patent Application No. 201510149037.5, filed Mar. 31, 2015, both of which are hereby incorporated by reference in their entireties.

### TECHNICAL FIELD

The present invention relates to the technical field of electronics, and more particularly, to a combined structure of a piezoelectric receiver and an ultrasonic generator.

### BACKGROUND

In the era of mobile internet, people are paying more and more attention on consumer electronic information products, and a large number of smart devices are brought in people's daily life. In human-computer interaction, application of gesture recognition enables operation and control of large-screen smart devices to be more convenient. With the development of science and deepening of research on basic materials, the number of sensors for the gesture recognition on a smart device is also increasing. A technology in which an ultrasonic echo positioning principle of piezoelectric ceramics is adopted to recognize a suspension gesture is also gradually developing. However, a traditional acoustic device on a mobile phone is relatively poor in ultrasonic frequency band performance and cannot meet the requirements of an ultrasonic sensor. Therefore, in order to realize this function, an ultrasonic signal generator, an ultrasonic transducer and an ultrasonic receiving sensor should be at least additionally arranged, resulting in too many components. Undoubtedly, a space and cost of the mobile phone are increased, and it challenges a thinner and lighter design trend of the mobile phones.

### SUMMARY

An object of the present invention is to provide a combined structure of a piezoelectric receiver and an ultrasonic generator. The adopted technical solutions are as follows.

A combined structure of a piezoelectric receiver and an ultrasonic generator comprises a piezoelectric plate, an ultrasonic signal generator, an audio signal input circuit and a switching circuit, wherein the input end of the switching circuit is connected with the ultrasonic signal generator and the audio signal input circuit, respectively, so as to switch therebetween; and the output end of the switching circuit is connected with the piezoelectric plate.

Optionally, the combined structure further comprises a mode recognition circuit for controlling the switching circuit.

Optionally, the combined structure further comprises an ultrasonic receiving sensor.

Optionally, the combined structure further comprises a shell; a boss is arranged at the inner side of the shell; and one end of the piezoelectric plate is adhered to the boss.

Optionally, the combined structure further comprises a counterweight adhered to the other end of the piezoelectric plate.

Optionally, the counterweight is adhered to the side, close to the shell, of the piezoelectric plate.

Optionally, the combined structure further comprises a shell on which a sensor groove is formed; the ultrasonic receiving sensor is arranged in the sensor groove; and a receiving side of the ultrasonic receiving sensor faces the outer side of the shell.

Optionally, an ultrasonic sounding channel is formed on the shell.

Optionally, there are two ultrasonic receiving sensors between which the ultrasonic sounding channel is located.

Optionally, the ultrasonic sounding channel is a honeycombed sounding hole.

The inventor of the present invention found that, a structure that combines the piezoelectric receiver with the ultrasonic generator is not yet provided by the prior art, so the present invention relates to a new technical solution.

The technical effect of the present invention is that the piezoelectric receiver and the ultrasonic generator are combined, such that the functions of the receiver and the ultrasonic generator can be achieved only through one piezoelectric plate, saving the cost and the space of electronic equipment.

Further features of the present invention and advantages thereof will become apparent from the following detailed description of exemplary embodiments according to the present invention with reference to the attached drawings.

### BRIEF DESCRIPTION OF THE DRAWINGS

The accompanying drawings, which are incorporated in and constitute a part of the specification, illustrate embodiments of the invention and, together with the description thereof, serve to explain the principles of the invention.

FIG. 1 shows a circuit block diagram of a combined structure of a piezoelectric receiver and an ultrasonic generator according to an embodiment of the present invention.

FIG. 2 is an exploded schematic view of the combined structure of the piezoelectric receiver and the ultrasonic generator according to the embodiment of the present invention.

FIGS. 3-5 show schematically structural back, front and side views of the combined structure of the piezoelectric receiver and the ultrasonic generator according to the embodiment of the present invention, respectively.

FIGS. 6-8 show a perspective view, a top view and a side view of a honeycombed structure, respectively.

FIG. 9 is a schematic view showing a principle when the combined structure of the piezoelectric receiver and the ultrasonic generator, provided by an embodiment of the present invention, is adopted to perform gesture recognition.

Description of reference numerals: 1, mode recognition circuit; 2, switching circuit; 3, audio signal input circuit; 4, ultrasonic signal generator; 5, power amplifying circuit; 6, piezoelectric plate; 7, ultrasonic receiving sensor; 8, ultrasonic processor; 11, double-sided adhesive tape; 12, double-sided adhesive tape; 13, flexible counterweight; 14, sensor groove; 15, boss; 16, ultrasonic sounding channel; 17, honeycombed structure; and 171, sounding hole.

### DETAILED DESCRIPTION

Various exemplary embodiments of the present invention will now be described in detail with reference to the drawings. It should be noted that the relative arrangement of the components and steps, the numerical expressions, and numerical values set forth in these embodiments do not limit the scope of the present invention unless it is specifically stated otherwise.

The following description of at least one exemplary embodiment is merely illustrative in nature and is in no way intended to limit the invention, its application, or uses.

Techniques, methods and apparatus as known by one of ordinary skill in the relevant art may not be discussed in detail but are intended to be part of the specification where appropriate.

In all of the examples illustrated and discussed herein, any specific values should be interpreted to be illustrative only and non-limiting. Thus, other examples of the exemplary embodiments could have different values.

Notice that similar reference numerals and letters refer to similar items in the following figures, and thus once an item is defined in one figure, it is possible that it need not be further discussed in the accompanying drawings.

A receiver, also called as a handset, is an electro-acoustic device that converts an audio electronic signal into a sound signal under a condition without sound leakage. The receiver is widely applied to communication terminal equipment such as a mobile phone, a fixed telephone, a hearing aid and the like to play an audio (including call voice, music, etc.). A circuit connection manner of a conventional piezoelectric receiver is illustrated by taking a mobile phone as an example. An audio signal (including call voice, music, etc.) input circuit is connected to a piezoelectric plate via a power amplifying circuit; the piezoelectric plate vibrates through a converse piezoelectric effect; and the vibration is transmitted to a panel of the mobile phone via a coupling structure connected with the panel, so as to successively make a sound. Here, the whole panel vibrates to make the sound, so that there is no need to form a sounding hole.

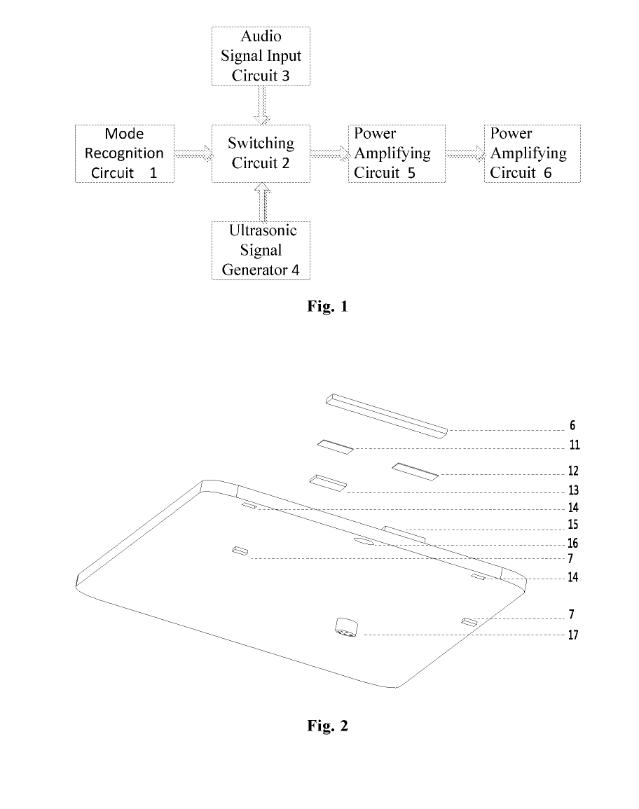

The piezoelectric plate can work well at a frequency band of 20 Hz-20 kHz (which is in an audible scope of a human ear) and at an ultrasonic frequency band above 20 kHz due to its excellent ultrasonic performance. Therefore, in the present invention, the receiver and the ultrasonic generator are combined by taking the piezoelectric receiver as a basis and adopting the excellent ultrasonic performance of the piezoelectric plate, and dual functions of audio playing and gesture recognition are realized based on different working frequency bands of the piezoelectric plate. A circuit connection may refer to FIG. 1. A mode recognition circuit 1 is configured to recognize an ultrasonic mode and other modes (for example, a call mode, a music playing mode, and the like); in the mobile phone, a mobile phone processor serves as the mode recognition circuit 1 which controls a switching circuit 2 to switch between an audio signal input circuit 3 and an ultrasonic signal generator 4; and the ultrasonic signal generator 4 is configured to generate an electrical signal of the ultrasonic frequency band. Under the ultrasonic mode, the switching circuit 2 is switched into the ultrasonic signal generator 4; an ultrasonic electric signal output by the ultrasonic signal generator 4 is input into the piezoelectric plate 6 via a power amplifying circuit 5; and the piezoelectric plate 6 generates a vibration due to the converse piezoelectric effect to make an ultrasonic wave. Under other modes, the switching circuit 2 is switched to the audio signal input circuit 3. Further, the combined structure further comprises ultrasonic receiving sensors configured to receive ultrasonic echoes, and an ultrasonic processor configured to calculate to realize gesture positioning.

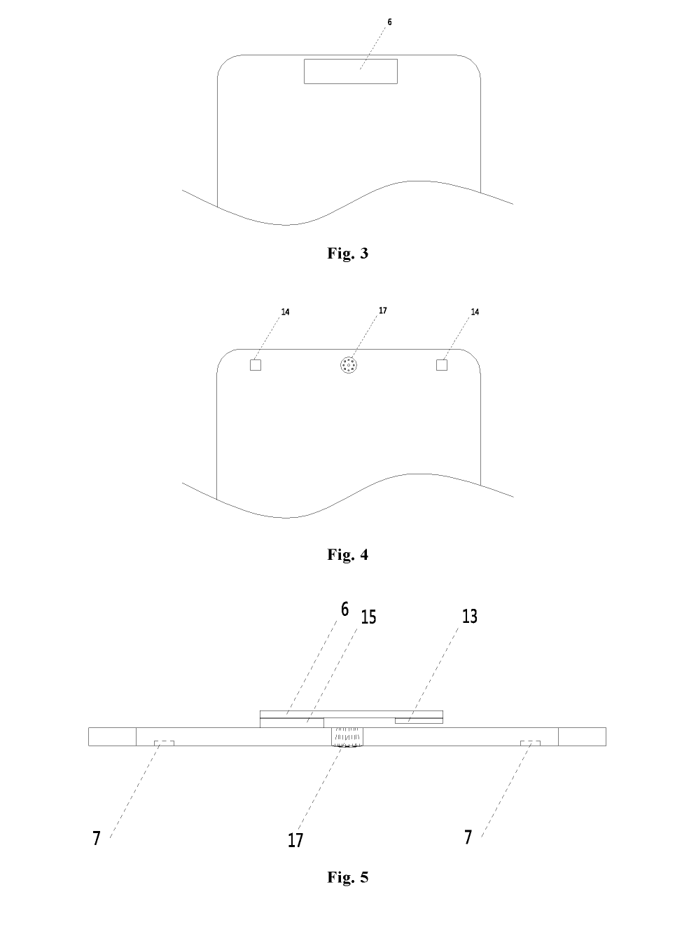

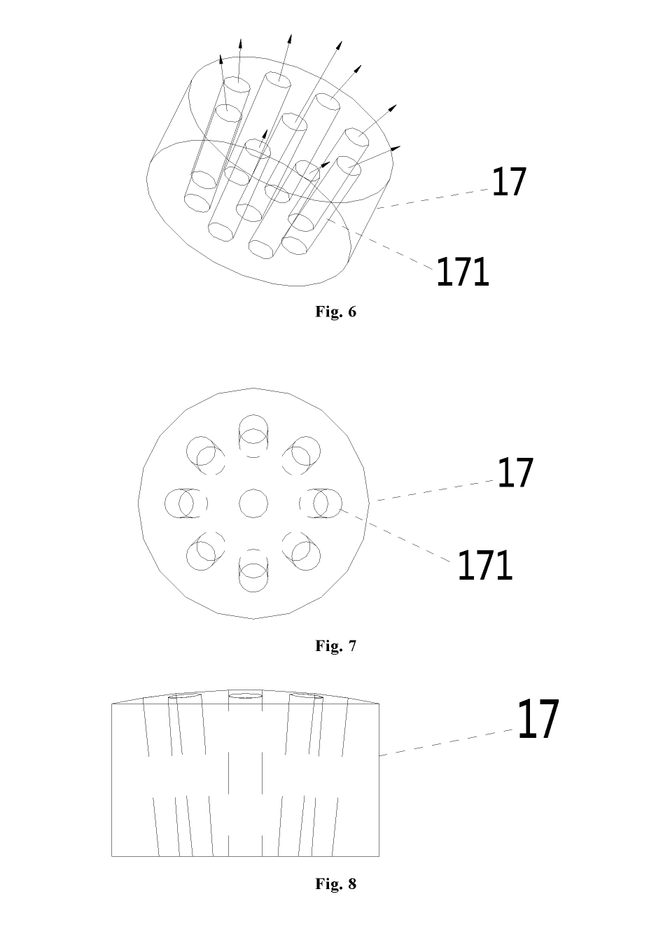

Specific arrangement manners of the combined structure of the piezoelectric receiver and the ultrasonic generator, provided by the present invention, are described with reference to FIGS. 2-5. A shell of electronic equipment is composed of panels. A boss 15 is arranged at a position, close to the edge, on a back surface of one of the panels; one end of the piezoelectric plate 6 is adhered to the boss 15 via a double-sided adhesive tape 12; and a flexible counterweight 13 is adhered to the other end of the piezoelectric plate 6 through a double-sided adhesive tape 11 and faces this panel. Through the flexible counterweight 13, vibration performance and resonant frequency of the piezoelectric plate 6 may be adjusted, wherein the back surface of the panel refers to the surface, facing the inside of the electronic equipment, of the panel. Two sensor grooves 14 are formed on the front surface of the panel, and are located at the two ends of the piezoelectric plate 6, respectively. Two ultrasonic receiving sensors 7 configured to receive the ultrasonic echoes are arranged in the sensor grooves 14, respectively; and the receiving ends of the ultrasonic receiving sensors 7 face the outer side of the shell. An ultrasonic sounding channel 16 is formed in this panel and located in the middle of the two sensor grooves 14, and a honeycombed structure 17 is arranged in the sounding channel. A specific structure of the honeycombed structure 17 can refer to FIGS. 6-8. It can be seen that sounding holes 171 are radially distributed to facilitate ultrasonic scattering.

The size of the ultrasonic sounding channel 16, the number, the shape and the arrangement manner of the sounding holes, and the positions, the number and the arrangement manner of the ultrasonic receiving sensors 7 can be further optimized according to an actual application environment.

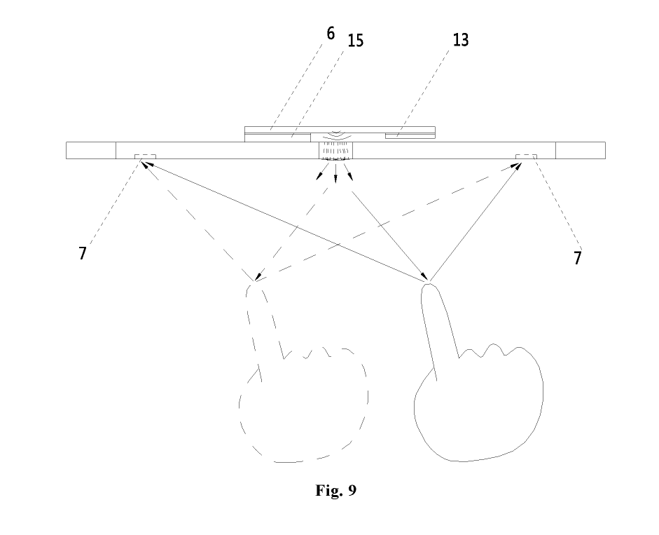

The principle of gesture recognition provided by an embodiment of the present invention is described with reference to FIG. 9. Under an ultrasonic gesture recognition mode, a finger moves; the piezoelectric plate 6 vibrates to make an ultrasonic; the ultrasonic receiving sensors 7 receive echoes; and the ultrasonic processor 8 calculates a reflection time difference to calculate a position of the finger, so that the gesture recognition is realized.

The technical effects of the combined structure of the piezoelectric receiver and the ultrasonic generator, provided by an embodiment of the present invention are as follows.

1. When working at the frequency band of 20 Hz-20 kHz, the combined structure may be used as a receiver.

2. When working at the frequency band above 20 kHz, the combined structure may be used as an ultrasonic generator.

3. The receiver and the ultrasonic generator are combined, so that the mobile phone space and cost are saved.

4. Through the combined structure of the piezoelectric receiver and the ultrasonic generator, provided by an embodiment of the present invention, a gesture recognition function can be realized.

Although some specific embodiments of the present invention have been demonstrated in detail with examples, it should be understood by a person skilled in the art that the above examples are only intended to be illustrative but not to limit the scope of the present invention. It should be understood by those skilled in the art that the above embodiments can be modified without departing from the scope and spirit of the present invention. The scope of the present invention is defined by the appended claims.

1. A combined structure of a piezoelectric receiver and an ultrasonic generator, comprising: a piezoelectric plate, an ultrasonic signal generator, an audio signal input circuit and a switching circuit, wherein the input end of the switching circuit is connected with the ultrasonic signal generator and the audio signal input circuit, respectively, so as to switch therebetween; and the output end of the switching circuit is connected with the piezoelectric plate.

2. The structure of claim 1, further comprising: a mode recognition circuit for controlling the switching circuit.

3. The structure of claim 1, further comprising: an ultrasonic receiving sensor.

4. The structure of claim 3, further comprising: a shell, wherein a boss is arranged at the inner side of the shell, and one end of the piezoelectric plate is adhered to the boss.

5. The structure of claim 4, further comprising: a counterweight adhered to the other end of the piezoelectric plate.

6. The structure of claim 5, wherein the counterweight is adhered to the side, close to the shell, of the piezoelectric plate.

7. The structure of claim 3, further comprising: a shell on which a sensor groove is formed, wherein the ultrasonic receiving sensor is arranged in the sensor groove, and a receiving side of the ultrasonic receiving sensor faces the outer side of the shell.

8. The structure of claim 7, wherein an ultrasonic sounding channel is formed on the shell.

9. The structure of claim 8, wherein there are two ultrasonic receiving sensors between which the ultrasonic sounding channel is located.

10. The structure of claim 8, wherein the ultrasonic sounding channel is a honeycombed sounding hole.
